(19) United States
(12) Patent Application Publication
(10) Pub. No.: US 2003/0060200 A1
(43) Pub. Date: Mar. 27, 2003

(54) Handoff method and apparatus with dual pilots in a communication system

(76) Inventor: Samir S. Soliman, San Diego, CA (US)

Correspondence Address: Sarah Kirkpatrick, Manager, Intellectual Property Administration, Qualcomm Incorporated, 5775 Morehouse Drive, San Diego, CA, 92121-1714, US

(21) Appl. No.: 09/965,079

(22) Filed: Sep. 27, 2001

(51) Int. Cl. H04Q 7/20

(52) U.S. Cl. 455/442; 455/443; 455/525

(57) ABSTRACT

A communication system (100) includes a method and apparatus for a hard handoff and followed by a soft handoff when a mobile station moves from a first cell site (110) to a second cell site (120) operating over the same frequency assignment. The communication system (100) includes a first cell site primary transceiver system (151) and a second cell site primary transceiver system (161) for providing communication coverage respectively in the first and second coverage areas (150, 160). A first cell site secondary transceiver system (162) and a second cell site secondary transceiver system (152) for providing communication coverage in respectively the second and first coverage area (160, 150). The hard handoff is between the first cell site primary transceiver system (151) and the second cell site secondary transceiver system (152), and the followed soft handoff is between the primary and the secondary transceiver systems (161, 152).

### FIELD

The present invention relates generally to the field of communications, and more particularly, to communications in a cellular communication system.

### BACKGROUND

A communication system may provide communication services that include wireless radio transmission of digitized speech, still or moving images, text messages and other types of data. Such communication services may be provided to a type of devices that are mobile, such as a cellular phone, a portable computer, etc. A communication system through a collection of commonly known cell sites provide the communication services without interruption over a broad range of areas to a mobile station. Each cell site may include a base transceiver station and associated control units. One cell site may have more than one base transceiver stations. Each base transceiver station provides the radio frequency link over a limited geographical area. When a mobile station moves from a location to another, the mobile station may go through a handoff process that allows providing the communication services without interruption. There are several types of handoff, as one ordinary skilled in the art may appreciate; namely, the handoff may be accomplished through a soft hand off or a hard handoff or both. In soft handoff, the mobile station receives essentially identical traffic channel data from at least two base transceiver stations. The base transceiver stations involved in the soft handoff process may be located in two different cell sites or the same cell site while operating over a common carrier frequency. In order to accomplish soft handoff, there needs to be a connection between the controllers or the base transceiver stations involved in the soft handoff process. Such a connection is necessary to allow the mobile station to receive essentially identical traffic data from both base transceiver stations in a timely and efficient manner. In hard handoff, the resources in one base station transceiver are released while new communication resources in a new base station are allocated to the mobile station. Generally, hard handoff occurs between cell sites that are operating over two different frequencies, or between two different systems.

To this end as well as others, there is a need for a system, method and apparatus for providing reliable and uninterrupted communication services in a communication system.

A communication system deployed over a geographical area includes a method and apparatus for a hard handoff and followed by a soft handoff when a mobile station moves from a first cell coverage area to a second cell site coverage area even though the first and second cell sites are operating over the same frequency assignment. The communication system includes a first cell site primary transceiver system for providing communication coverage in the first coverage area and a second cell site primary transceiver system for providing communication coverage in the second coverage area. A first cell site secondary transceiver system for providing communication coverage in the second coverage area and a second cell site secondary transceiver system for providing communication coverage in the first coverage area are included in the communication system. The first cell site primary and the second cell site secondary transceiver systems are located within a first common area and the second cell site primary and the first cell site secondary transceiver systems are located within a second common area. The hard handoff is between the first cell site primary transceiver system and the second cell site secondary transceiver system, and the followed soft handoff is between the primary and the secondary transceiver systems of the second cell site, when the mobile station moves from the first cell site to the second cell site.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates a communication system in accordance with various embodiments of the invention;

FIG. 2 illustrates a communication system receiver for receiving and decoding received data;

FIG. 3 illustrates a communication system transmitter for transmitting data on a traffic channel, a primary pilot channel and a secondary pilot channel in accordance with various embodiments of the invention; and

FIG. 4 illustrates a graph of pilot signal strength available for a mobile station across two cell sites in a communication system in accordance with various aspects of the invention.

### DETAILED DESCRIPTION OF THE EMBODIMENT(S)

Various embodiments of the invention may be incorporated in a system for wireless communications in accordance with the code division multiple access (CDMA) technique which has been disclosed and described in various standards published by the Telecommunication Industry Association (TIA) and other standards organizations. Such standards include the TIA/EIA-95 standard, TIA/EIA-IS-2000 standard, IMT-2000 standard, UMTS and WCDMA standard, all incorporated by reference herein. A system for communications of data is also detailed in the “TIA/EIA/IS-856 cdma2000 High Rate Packet Data Air Interface Specification,” incorporated by reference herein. A copy of the standards may be obtained by accessing the world wide web at the address: http://www.3qpp2.org, or by writing to TIA, Standards and Technology Department, 2500 Wilson Boulevard, Arlington, Va. 22201, United States of America. The standard generally identified as UMTS standard, incorporated by reference herein, may be obtained by contacting 3GPP Support Office, 650 Route des Lucioles-Sophia Antipolis, Valbonne-France.

Generally stated, a novel and improved system, method and apparatus provide for efficient use of communication resources in a CDMA communication system. The efficient use of the communication resources includes providing communication services to a mobile user without interruption when the mobile user moves from the coverage area of one cell site to another. One or more exemplary embodiments described herein are set forth in the context of a digital wireless data communication system. While use within this context is advantageous, different embodiments of the invention may be incorporated in different environments or configurations. In general, the various systems described herein may be formed using software-controlled processors, integrated circuits, or discrete logic. The data, instructions, commands, information, signals, symbols, and chips that may be referenced throughout are advantageously represented by voltages, currents, electromagnetic waves, magnetic fields or particles, optical fields or particles, or a combination thereof. In addition, the blocks shown in each block diagram may represent hardware or method steps.

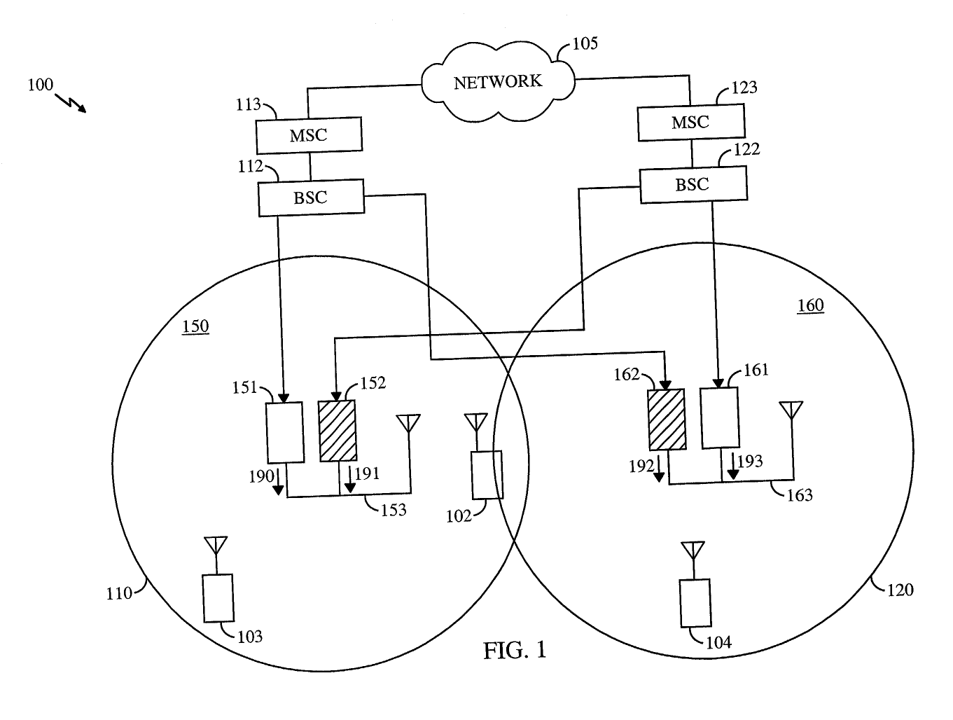

FIG. 1 illustrates a block diagram of a communication system 100 in accordance with various embodiments of the invention while operating in compliance with any of the code division multiple access (CDMA) communication system standards. Communication system 100 may be for communications of voice, data or both. Generally, communication system 100 may provide communication services over at least two cell sites 110 and 120. One ordinary skilled in the art may appreciate that the term “cell site” is a general term used to describe a collection of hardware and related software embedded therein for providing communication services over a limited geographical area. A cell site may be divided into two or more sectors, where each sector may have a collection of hardware and related software embedded therein for providing communication services over a limited geographical area. Two or more sectors may make up a cell site. Therefore, the terms cell site and sector used herein may be interchangeable without departing from the main scope and advantages of the invention. In various embodiments, the sites 110 and 120 may be two sectors of a common cell site, or one sector of a cell site and one sector of another cell site, or one sector of a cell site and an omni sector cell site.

Communication system 100 provides communication links between a number of mobile stations, such as mobile stations 102-104, and between the mobile stations 102-104 and a public switch telephone and data network 105. The mobile stations in FIG. 1 may be referred to as data access terminals without departing from the main scope and various advantages of the invention. Cell site 110 may include a primary base transceiver station (BTS) 151, a base station controller (BSC) 112 and a mobile station controller (MSC) 113. MSC 113 may be connected to network 105. BSC 112 may be connected to several primary base transceiver stations (not shown). Each BTS may provide coverage in a certain area. MSC 113 may also be connected to several base station controllers (not shown). Cell site 120 may also include a primary BTS 161, BSC 122 and MSC 123. MSC 123 may be connected to network 105. BSC 122 may be connected to several primary base transceiver stations (not shown). MSC 123 may also be connected to several BSC 122 (not shown). For simplicity, only one primary BTS, BSC and MSC is shown in cell sites 110 and 120. A cell site may include a number of other components not shown for simplicity.

Each cell site provides communication services to each mobile station that is in its coverage area via a forward link signal. The forward link signals targeted for several mobile stations may be summed to form a forward link signal targeted for the mobile stations. Each of the mobile stations 102-104 receiving a forward link signal decodes the forward link signal to extract the information that is targeted for its user. Mobile stations 102-104 communicate with the cell sites 110 and 120 via corresponding reverse links. Each reverse link is maintained by a reverse link signal.

In one embodiment, cell site 110 may provide communication services to mobile stations 102 and 103, and cell site 120 may be providing communication services to mobile stations 102 and 104. Mobile station 102, in such an embodiment, may be in soft handoff with both cell sites 110 and 120. For a soft handoff situation to occur, mobile station 102 may be in the coverage areas of both cell sites 110 and 120 to maintain communications with both cell sites 110 and 120. On the forward link, cell site 110 transmits on a forward link signal and cell sites 120 on another forward link signal for reception by mobile station 102. On the reverse link, mobile station 102 transmits on a reverse link signal to be received by both cell sites 110 and 120. For transmitting a data packet on a traffic channel to mobile station 102 in soft handoff, cell sites 110 and 120 transmit essentially identical information and essentially synchronously to the mobile station 102. The mobile station 102 attempts to receive both signals and combines the results in the decoding process. On the reverse link, both cell sites 110 and 120 may attempt to decode the traffic data transmission from the mobile station 102. The cell sites 110 and 120 may also transmit a pilot channel on the forward link to assist the mobile stations in decoding various channels on the forward link.

For a successful soft hand handoff, cell sites 110 and 120 need to have a connection between primary BTS 151 and BTS 161, or between BSC 112 and BSC 122, or between MSC 113 and MSC 123, or any combinations thereof. Establishing and maintaining a soft handoff condition is more difficult when the cross connection is at a high level in the chain of the equipments in each cell site. For example, it is more difficult to establish and maintain a soft handoff condition when the connection is between MSC 113 and MSC 123 than a connection between primary BTS 151 and BTS 161. One reason for such a difficulty is for the cell sites to coordinate passing the traffic data message to a higher level and proper and on time delivery to maintain a successful soft handoff.

Various embodiments of the invention provides an efficient system, method and apparatus for providing uninterrupted communication services in a communication system where two adjacent cell sites operate on a common frequency without a connection at an adequate level for providing an effective soft handoff. In accordance with various embodiments of the invention, a communication system 100 includes a first cell site 110 and a second cell site 120. The first and second cell sites 110 and 120 may be operating over a common carrier frequency. The first cell site 110 includes a primary base transceiver system 151 for providing communication coverage in a first coverage area 150. The second cell site 120 includes a primary base transceiver system 161 for providing communication coverage in a second coverage area 160. The first cell site 110 moreover includes a secondary base transceiver system 152 coupled to an antenna system 153 of the first cell primary base transceiver system 151 for providing communication coverage in the first coverage area 150. The second cell site 120 moreover includes a secondary base transceiver system 162 coupled to an antenna system 163 of the second cell primary base transceiver system 161 for providing communication coverage in the second coverage area 160. Therefore, a mobile station moving from first coverage area 150 to the second coverage area 160 may perform a frequency inter-system hard handoff between the primary base transceiver system 151 and secondary base transceiver system 152. As the mobile station traverses the boundary between the two coverage areas, the mobile station may perform a soft handoff with both secondary base transceiver system 152 and primary base transceiver system 161. Similarly, as the mobile station moves from the second coverage area 160 to the first coverage area 150, the mobile station may perform a frequency inter-system hard handoff between primary base transceiver system 161 and secondary base transceiver system 162. As the mobile station traverses the boundary between the two coverage areas 150 and 160, the mobile station may perform soft handoff with both secondary base transceiver system 162 and primary base transceiver system 151. As such, the mobile station receives uninterrupted communication services. In accordance with an aspect of the invention, the communications in the first and second coverage areas 150 and 160 are over a common carrier frequency.

In accordance with various embodiments of the invention, the first cell site primary antenna system 153 is coupled to the first cell site primary base transceiver system 151 for providing communication coverage in the first coverage area 150. Moreover, the second cell site primary antenna system 163 is coupled to the second cell primary base transceiver system 161 for providing communication coverage in the second coverage area 160. The secondary transceiver system 152 is also coupled to antenna system 153 in accordance with an embodiment. The secondary base transceiver system 162 is coupled to antenna system 163 in accordance with an embodiment. The primary and secondary base transceiver systems 151 and 152 may be located within a first common area. The primary and secondary base transceiver systems 161 and 162 may be located within a second common area. As such, a mobile station moving from the first coverage area 150 to the second coverage area 160 would experience uninterrupted communication services, although the system in the cell site 110 does not have a connection at BTS, BSC or MSC levels to the system in the cell site 120.

The system in the first cell site 110 may include a first cell site base station controller 112 coupled to the primary transceiver systems 151 and secondary base transceiver station 162. A first cell site mobile station controller 113 is also coupled to the first cell site base station controller 112. The system in the second cell site 120 may include a second cell site base station controller 122 coupled to the primary base transceiver systems 161 and secondary base transceiver station 152. A second cell site mobile station controller 123 may be coupled to the second cell site base station controller 122. A land-based network 105 may be coupled to the first and second cell sites 1 10 and 120 for providing land-based communications.

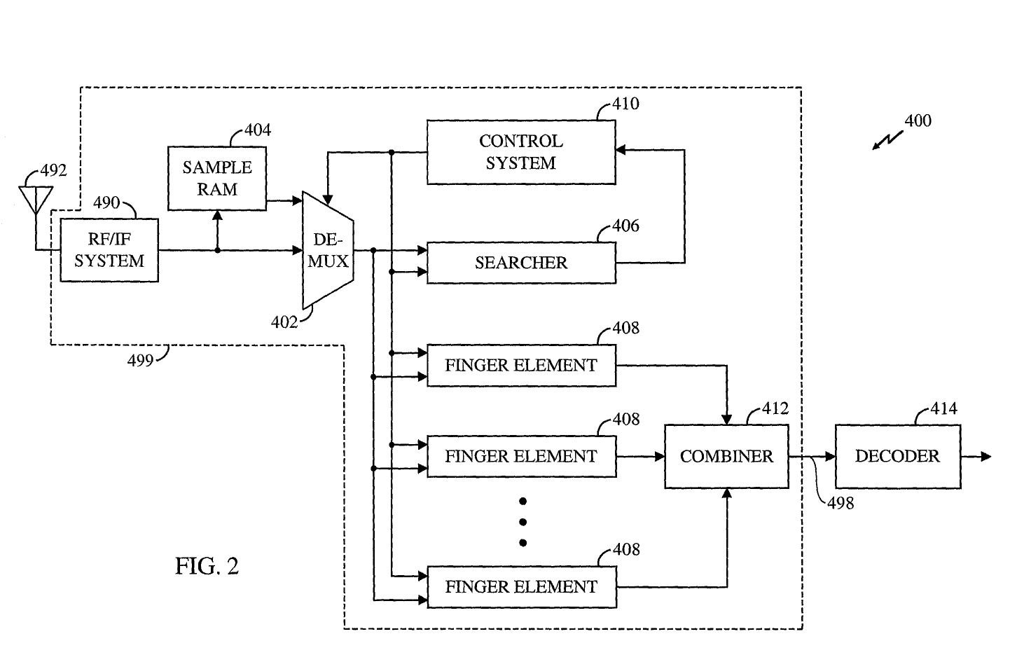

FIG. 2 illustrates a block diagram of a receiver 400 used for processing and demodulating the received CDMA signal. Receiver 400 may be used for decoding the information on reverse and forward links signals. Received (Rx) samples may be stored in RAM 404. Receive samples are generated by a radio frequency/intermediate frequency (RF/IF) system 490 and an antenna system 492. Antenna system 492 receives an RF signal, and passes the RF signal to RF/IF system 490. RF/IF system 490 may be any conventional RF/IF receiver. The received RF signals are filtered, down-converted and digitized to form RX samples at base band frequencies. The samples are supplied to a demultiplexer (demux) 402. The output of demux 402 is supplied to a searcher unit 406 and finger elements 408. A control unit 410 is coupled thereto. A combiner 412 couples a decoder 414 to finger elements 408. Control unit 410 may be a microprocessor controlled by software, and may be located on the same integrated circuit or on a separate integrated circuit. The decoding function in decoder 414 may be in accordance with soft-output Viterbi algorithm concatenated or a turbo decoder.

During operation, received samples are supplied to demux 402. Demux 402 supplies the samples to searcher unit 406 and finger elements 408. Control unit 410 configures finger elements 408 to perform demodulation of the received signal at different time offsets based on search results from searcher unit 406. The searcher 406 may monitor pilot channels transmitted from different base station transceivers. The searched results include an estimate of PN offset of the transmitted pilot channel. Each base station transceiver may used a different PN offset to distinguish its pilot channel from other pilot channels transmitted by other base station transceivers in the area. Before a traffic channel is acquired, the receiver needs to acquire an estimate of the PN offset of the base station that is transmitting the traffic channel data. The results of the demodulation are combined and passed to decoder 414. Decoder 414 decodes the data and outputs the decoded data. Despreading of the channels is performed by multiplying the received samples with the complex conjugate of the PN sequence and assigned Walsh function at a single timing hypothesis and digitally filtering the resulting samples, often with an integrate and dump accumulator circuit (not shown). Such a technique is commonly known in the art.

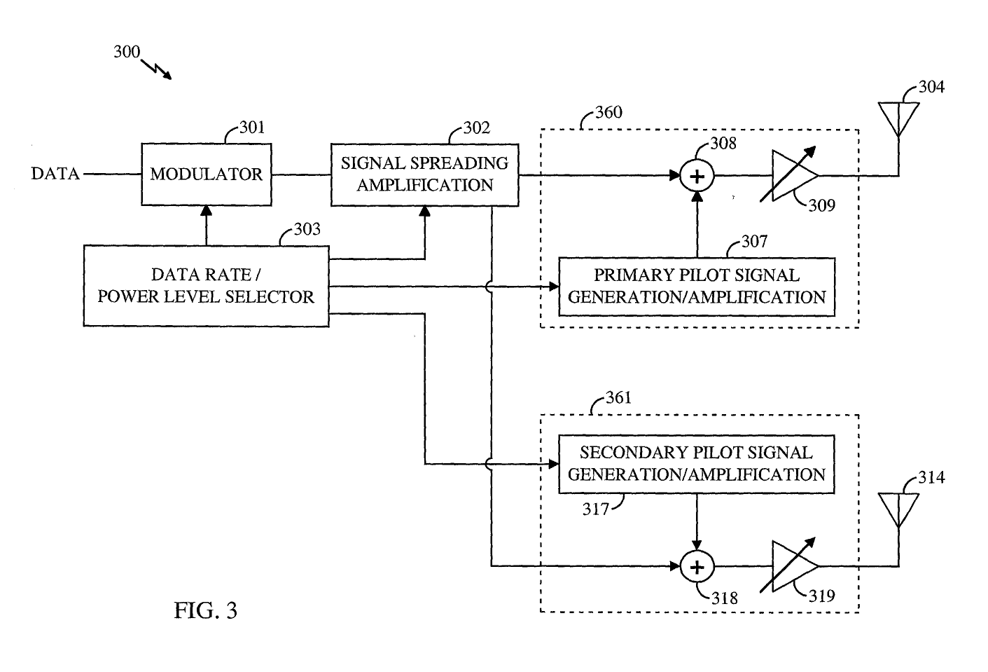

FIG. 3 illustrates a block diagram of a transmitter 300 in accordance with various aspects of the invention. Transmitter 300 may be used for the primary and secondary base transceiver stations 151 and 162 and the primary and secondary base transceiver stations 161 and 152. Transmitter 300 may be combined with receiver 400 shown in FIG. 2 to produce a transceiver system. Transmitter 300 includes a modulator 301 for receiving the traffic channel data. A traffic channel data for transmission are input to modulator 301 for modulation. The modulation may be according to any of the commonly known modulation techniques such as QAM, PSK or BPSK. The data is encoded at a data rate in modulator 301. The data rate may be selected by a data rate and power level selector 303. The data rate selection may be based on feedback information from a receiving destination. The information may include a data rate request and report of a channel condition at the receiver. The data rate and power level selector 303 accordingly selects the data rate in modulator 301. The output of modulator 301 passes through a signal spreading operation and amplified in a block 302. Transmitter 300 includes a primary and secondary base transceiver systems 360 and 361. The primary transceiver system 360 is coupled to an antenna system 304. The secondary transceiver system 361 is coupled to another antenna system 314. The primary transceiver system 360 and antenna system 304 are used for the primary communication to a mobile station in accordance with various embodiments of the invention. The secondary transceiver system 361 and antenna system 314 are used for the secondary communication to a mobile station in accordance with various embodiments of the invention.

The primary transceiver system 360 includes a block 307 for generating a primary pilot signal. The primary pilot signal is amplified to an appropriate level in block 307. The primary pilot signal power level may be in accordance with the channel condition at a receiving end. The primary pilot signal is combined with the traffic channel signal in a combiner 308. The combined signal may be amplified in an amplifier 309 and transmitted from the antenna system 304. The combination of the selected data rate and the power level allows proper decoding at the receiving destination of the data transmitted through the primary transceiver system 360.

The secondary transceiver system 360 includes a block 317 for generating a secondary pilot signal. The secondary pilot signal is amplified to an appropriate level in block 317. The secondary pilot signal power level may be in accordance with the channel condition at a receiving end. The secondary pilot signal is combined with the traffic channel signal in a combiner 318. The combined signal may be amplified in an amplifier 319, and the amplified signal is transmitted from the antenna system 314. The combination of the selected data rate and the power level allows proper decoding at the receiving destination of the data transmitted through the secondary transceiver system 360. To allow a receiving destination to distinguish the primary and secondary pilot channels, different PN offsets may be used in the primary and secondary transceiver systems 360 and 361.

While referring to FIG. 1 again, to perform the hard handoff and the following soft handoff, in accordance with various embodiments, the first cell site primary base transceiver system 151 transmits in the first coverage area 150 a first cell primary pilot signal 190. The secondary transceiver system 162 transmits in the second coverage area 160 a secondary pilot signal 192. The primary transceiver system 161 transmits in the second coverage area 160 a second cell primary pilot signal 193. The secondary transceiver system 152 transmits in the first coverage area 150 a secondary pilot signal 191. In accordance with an embodiment, the PN offset of the pilot signals 190-93 may be different. The hard handoff from the first cell site primary transceiver system 151 to the second cell site secondary transceiver system 152 includes acquiring PN offsets of the first cell site primary pilot signal 190 and the second cell site secondary pilot signal 191. The soft handoff with the secondary transceiver system 152 and the primary transceiver system 161 includes acquiring PN offsets of the secondary pilot signal 191 and the primary pilot signal 193. However, in the process, the mobile station may use the acquired offset value of the secondary pilot signal 191 from the hard handoff process in the soft handoff process. The receiver 400, shown in FIG. 2, is suitable for acquiring the PN offsets of different pilot signals as explained and shown through various blocks of the receiver portion 499. The control system 409 may keep track of various pilot signal PN offsets, and make the PN offset information available when the receiver portion 499 is operating on a received signal as explained and shown. Transmitter 300 is also suitable for transmitting the primary and secondary pilot signals in each cell site.

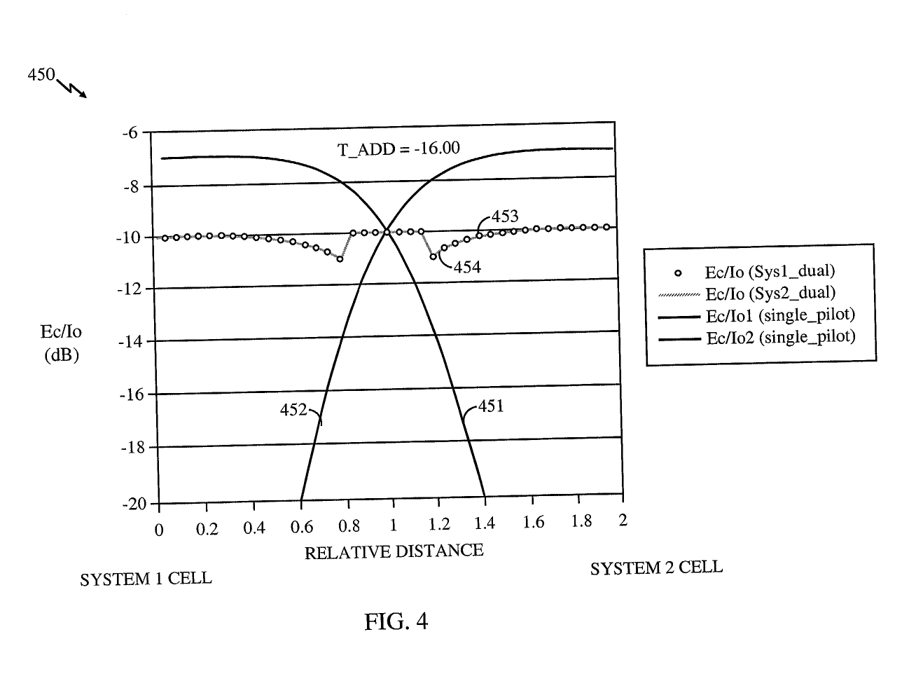

Referring to FIG. 4, a graph 450 depicts the possible values of the pilot signals strength experienced by a mobile station at different locations from a center of the first cell site 110, for example. Signal strength traces 451 and 452 depict the signal strength of the first and second primary pilot signals 190 and 193. Note, the signal strength of the pilot signal 190 as shown by the trace 451 is strong at the center of the first cell site 110 and drops off very quickly at the fringe area. At the fringe area, the signal strength of the second cell site 120 is also weak. As such, the mobile station traveling from the first cell site 110 to the second cell site 120 fails to have a quick hard handoff between the first cell site 110 and the second cell site 120. In the system in accordance with various aspects of the invention, by having a dual system of pilot signals, the signal strength of the pilot signals as experienced by the mobile station would have a trace such as the traces 453 and 454. The trace 453 may be the pilot signal strength experienced by a mobile station traveling from the first cell site 110 to the second cell site 120. The trace 454 may be the pilot signal strength experienced by a mobile station traveling from the second cell site 120 to the first cell site 110. Therefore, in accordance with various aspects of the invention, a mobile station may receive uninterrupted communication services where two adjacent cell sites operate on a common frequency without a connection at an adequate level for providing an effective soft handoff.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

a. The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed is:

1. A communication system comprising:
a first cell site primary transceiver system for providing communication coverage in a first coverage area;
a second cell site primary transceiver system for providing communication coverage in a second coverage area;
a first cell site secondary transceiver system for providing communication coverage in said second coverage area; and
a second cell site secondary transceiver system for providing communication coverage in said first coverage area, wherein communications in said first and second coverage area are over a common carrier frequency.

2. The communication system as recited in claim 1 further comprising:
a first cell site antenna system coupled to said first cell site primary transceiver system for providing communication coverage in said first coverage area;
a second cell site antenna system coupled to said second cell site primary transceiver system for providing communication coverage in said second coverage area; and
wherein said first cell site secondary transceiver system is coupled to said second cell site antenna system for providing communication coverage in said second coverage area;
wherein said second cell site secondary transceiver system is coupled to said first cell cite antenna system for providing communication coverage in said first coverage area.

3. The communication system as recited in claim 1 wherein said first cell site primary and said second cell site secondary transceiver systems are located within a first common area.

4. The communication system as recited in claim 1 wherein said second cell site primary and first cell site secondary transceiver systems are located within a second common area.

5. The communication system as recited in claim 1 further comprising:
a mobile station configured for performing a hard handoff between said first cell site primary transceiver system and said second cell site secondary transceiver system followed by a soft handoff with said second cell site primary transceiver system and said second cell site secondary transceiver system while moving from said first cell site to said second cell site.

6. The communication system as recited in claim 1 further comprising:
a first cell site base station controller coupled to said first cell site primary and secondary base transceiver systems;
a first cell site mobile station controller coupled to said first cell site base station controller.

7. The communication system as recited in claim 1 further comprising:
a second cell site base station controller coupled to said second cell site primary and secondary base transceiver systems; and
a second cell site mobile station controller coupled to said second cell site base station controller.

8. The communication system as recited in claim 1 further comprising:
a land based network coupled to said first and second cell sites for providing land based communications to said first and second cell sites.

9. A method comprising:
installing a first cell site primary transceiver system for providing communication coverage in a first coverage area;
installing a second cell site primary transceiver system for providing communication coverage in a second coverage area;
coupling a first cell site secondary transceiver system to an antenna system of said second cell primary transceiver system for providing communication coverage in said second coverage area; and
coupling a second cell site secondary transceiver system to an antenna system of said first cell primary transceiver system for providing communication coverage in said first coverage area.

10. The method as recited in claim 9 further comprising:
operating a communication system including said first and second cell sites over a common carrier frequency assignment.

11. The method as recited in claim 9 further comprising:
locating said first cell site primary and said second cell site secondary transceiver systems within a first common area.

12. The method as recited in claim 9 further comprising:
locating said second cell site primary and said first cell site secondary transceiver systems within a second common area.

13. The method as recited in claim 9 further comprising:
coupling a first cell site base station controller to said first cell site primary and secondary transceiver systems; and
coupling a first cell site mobile station controller to said first cell site base station controller.

14. The method as recited in claim 9 further comprising:
coupling a second cell site base station controller to said second cell site primary and secondary transceiver systems; and
coupling a second cell site mobile station controller to said second cell site base station controller.

15. The method as recited in claim 9 further comprising:
coupling a land based network to said first and second cell sites for providing land based communications to said first and second cell sites.

16. The method as recited in claim 9 further comprising:
performing a hard handoff, for a mobile station, between said first cell site primary transceiver system and said second cell site secondary transceiver system; and
performing a soft handoff, followed after said hard handoff, with said second cell site secondary transceiver system and said second cell site primary transceiver system.

17. A processor for use in a communication receiver comprising:
a controller system coupled to a receiving system configured for:
acquiring PN offset of a primary pilot signal transmitted from a first cell site primary transceiver system in a first coverage area of said first cell site,
acquiring PN offset of a secondary pilot signal transmitted in a second coverage area of a second cell site from a secondary transceiver system of said first cell site,
acquiring PN offset of a primary pilot signal transmitted from a primary transceiver system of said second cell site in said second coverage area; and
acquiring PN offset of a secondary pilot signal transmitted from said second cell site secondary transceiver system transmitting in said first coverage area, wherein said first and second cells primary and secondary pilot signals use different PN offsets, wherein said pilot signals are transmitted over a common frequency assignment.

18. The processor as recited in claim 17 wherein said controller system coupled to said receiving system further configured for:
performing a hard handoff for said mobile station from said first cell site primary transceiver system to said second cell site secondary transceiver system and performing a soft handoff, following said hard handoff, for said mobile station with said second cell site secondary transceiver system and said second cell site primary transceiver system.

19. A method for providing uninterrupted communication services to a mobile station comprising:
performing a hard handoff for said mobile station from a first cell site primary transceiver system to a second cell site secondary transceiver system, wherein said first cell site primary transceiver and said second cell site secondary transceiver independently provide for communication coverage in a first coverage area, and wherein said second cell site secondary transceiver is coupled to an antenna system of said first cell primary transceiver system; and
performing a soft handoff, following said hard handoff, for said mobile station with said second cell site secondary transceiver system and said second cell site primary transceiver system, wherein said second cell primary transceiver system provides for communication coverage in a second coverage area, thus allowing said mobile station to have uninterrupted communication services while moving from said first communication coverage area to said second communication coverage area.

20. The method as recited in claim 19 further comprising:
transmitting, in said first coverage area of said first cell site, a primary pilot signal from said first cell site primary transceiver system;
transmitting, in said second coverage area of said second cell site, a secondary pilot signal from said first cell site secondary transceiver system,
transmitting, in said second coverage area, a primary pilot signal from said second cell site primary transceiver system; and
transmitting, in said first coverage area, a secondary pilot signal from said second cell site secondary transceiver system, wherein said first and second cells primary and secondary pilot signals use different PN offsets.

21. The method as recited in claim 20 wherein said hard handoff from said first cell site primary transceiver system to said second cell site secondary transceiver system includes:
acquiring PN offsets of said first cell site primary pilot signal and said second cell sites secondary pilot signal.

22. The method as recited in claim 20 wherein said soft handoff with said second cell site secondary transceiver system and said second cell site primary transceiver system includes:
acquiring PN offsets of said second cell site secondary pilot signal and said second cell site primary pilot signal.

23. An apparatus for transmitting signals in a communication system comprising:
a primary pilot signal generator for generating a primary pilot signal;
a traffic data channel modulator for generating modulated traffic channel data;
a primary combiner for combining said modulated traffic channel data with said primary pilot signal to generate a primary combined signal;
a primary antenna system for transmitting said primary combined signal in a first coverage area of a first cell site;
a secondary pilot signal generator for generating a secondary pilot signal;
a secondary combiner for combining said modulated traffic channel data with said secondary pilot signal to generate a secondary combined signal; and
a secondary antenna system for transmitting said secondary combined signal in a second coverage area of a second cell site.
